(19) United States
(12) Patent Application Publication
(10) Pub. No.: US 2022/0168912 A1
(43) Pub. Date: Jun. 2, 2022

(54) GROOMING DEVICE

(71) Applicant: Steven Abramsky, Cuba City, WI (US)

(72) Inventor: Steven Abramsky, Cuba City, WI (US)

(21) Appl. No.: 17/675,207

(22) Filed: Feb. 18, 2022

Related U.S. Application Data
(63) Continuation-in-part of application No. 16/751,885, filed on Jan. 24, 2020, now abandoned.
(60) Provisional application No. 62/796,682, filed on Jan. 25, 2019.
(60) Provisional application No. 63/157,874, filed on Mar. 8, 2021.

(51) Int. Cl. B26B 21/40; B26B 21/08; B26B 21/52

(52) U.S. Cl. CPC B26B 21/4006; B26B 21/08; B26B 21/521; B26B 21/4025; B26B 21/4018

(57) ABSTRACT

A grooming device having a housing with a blade receiving section and a handle section. A blade is disposed within the blade receiving section of the housing and retained within the housing by a removable cap. The handle section is removably connected to a holder. Preferably, the housing has a circular top edge and bottom edge that have diameters greater than a transition section in-between.

### CROSS REFERENCE TO RELATED APPLICATION

This application is a continuation-in-part of U.S. application Ser. No. 16/751,885 filed Jan. 24, 2020, which claims the benefit of U.S. Provisional Application No. 62/796,682 filed Jan. 25, 2019, and also claims the benefit of U.S. Provisional Application No. 63/157,874 filed Mar. 8, 2021, the contents of these applications are hereby incorporated by reference in their entirety.

### BACKGROUND OF THE INVENTION

The present invention is directed to a grooming device and more particularly a grooming device for use with shaving and exfoliating.

Shaving devices are well-known in the art. Many of these devices are complex in their design, require unidirectional movement, cause skin irritation through microscopic sheering along the skin's surface, get hairs caught between the blades and often require replacement blades when the original blades become worn. Some choose to replace the entire disposable shaving device, rather than the blade alone, causing environmental damage. Not only are these devices cumbersome and inefficient, but the majority are limited to the single use of shaving. Accordingly, there is a need in the art for a device that addresses these deficiencies.

An objective of the present invention is to provide a grooming device that is compact and efficient to use.

Another objective of the present invention is to provide a grooming device adapted for multiple users and use cases.

These and other objectives will be apparent to those having ordinary skill in the art based upon the following written description, drawings, and claims.

### SUMMARY OF THE INVENTION

The grooming device has a housing having a blade receiving section and a handle section. Preferably, the blade receiving section is cone- or funnel-shaped and extends from a circular top edge to a middle wall to form a chamber for collecting hair. The handle section combined with the blade receiving section preferably form a cake stand shape with a transition section having a diameter smaller than the top edge and a bottom edge of the housing.

A blade is disposed within the blade receiving section of the housing, is preferably circular, and has a plurality of holes that fill a surface area of the blade. The blade is also concave in relation to the middle wall.

The blade is retained within the blade receiving section by a cap that is removably connected to the housing. Preferably the cap is ring shaped with a central opening. An exfoliating cover can be placed over the cap to provide additional applications for the device.

The handle section is removably connected to a holder. Preferably, both the handle section and the holder have magnets that attract one another.

### BRIEF DESCRIPTION OF THE DRAWINGS

FIG. 1 is an exploded perspective view of a grooming device;

FIG. 2 is a side sectional view of a housing of a grooming device;

FIG. 3 is a side view of a blade of a grooming device;

FIG. 4 is a top plan view of a housing of a grooming device;

FIG. 5 is a side view of a portion of a grooming device;

FIG. 6 is a side sectional view of a portion of a blade for a grooming device;

FIG. 7 is a perspective view of a grooming device;

FIG. 8 is a side sectional view of a grooming device;

FIG. 9 is a top perspective view of a grooming device;

FIG. 10 is an exploded perspective view of a grooming device;

FIG. 11 is a side sectional view of a grooming device;

FIG. 12 is a side sectional view of a blade for a grooming device; and

FIG. 13 is a side sectional view of a blade for a grooming device.

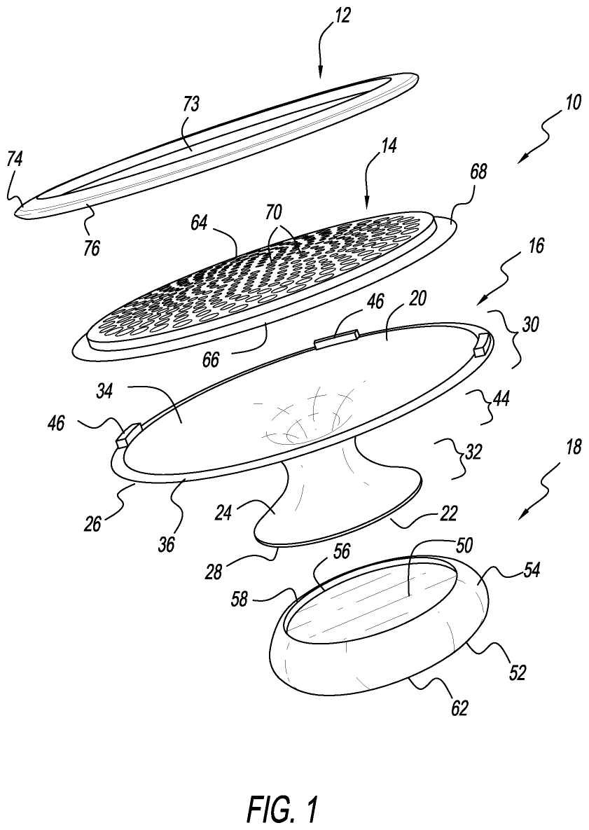

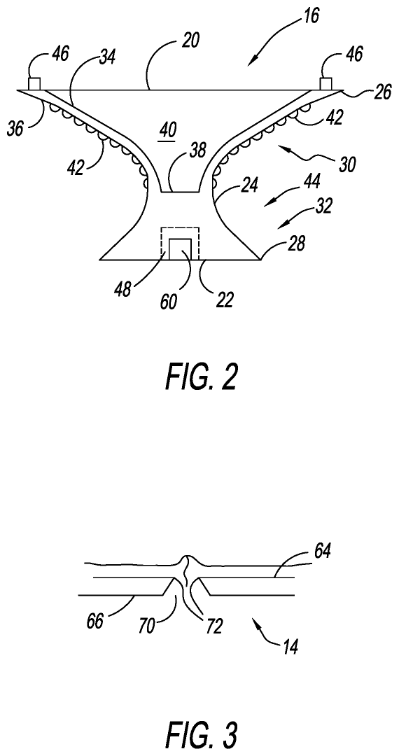

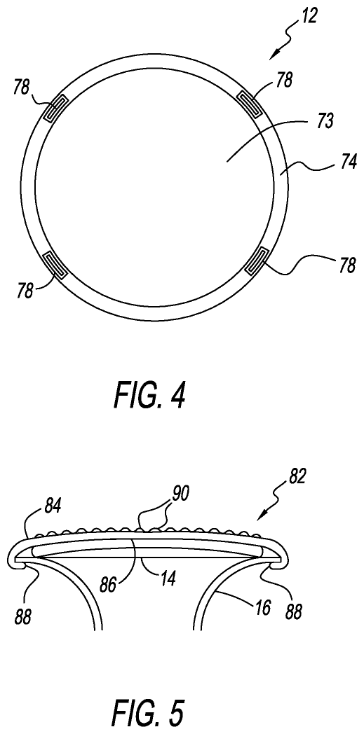

### DETAILED DESCRIPTION OF THE PREFERRED EMBODIMENTS

Referring to the Figures, a grooming device 10 includes a cap 12, a blade or foil 14, a housing 16, and a holder 18. The housing 16 has an open top 20, a bottom 22, and a side wall 24. Preferably, the side wall 24 extends from a top edge 26 to a bottom edge 28 in a curved manner that is concave to a central vertical axis of the housing 16 to form a blade receiving section 30 and a handle section 32.

The blade receiving section 30 has an inner surface 34 and an outer surface 36. The inner surface 34 curves from the top edge 26 to a middle wall 38 that forms a chamber 40 for collecting cut hair. The outer surface 36 has a plurality of raised or lowered portions 42 to provide an anti-slip surface. The diameter of the top edge 26 is greater than the bottom edge 28 and both are larger than a diameter of a transition section 44 that dwells in between. The design is adapted to permit one to hold the housing 16 by grasping the transition section 44 with a finger on both sides while engaging the back surface 36 of the blade receiving section 30 and the handle section 32. Attached to and extending vertically away from the top edge 26 are a plurality of radially spaced projections or clips 46. The handle section 32 has a magnet 48 attached to or preferably embedded within the handle section 32.

The handle section 32 of the housing 16 is removably connected to the holder 18. The holder 18 is of any size, shape, and structure. In the example shown, the holder 18 has a top 50, a bottom 52, and an arcuate concave side wall 54. The side wall 54 has a top edge 56 that curves above the top 50 and forms a shoulder 58. The top edge 56 has a diameter adapted to receive the bottom edge 28 of the handle portion 32. Attached to, and preferably embedded within, the holder 18 is a magnet 60. Attached to the bottom 52 of the holder 18 is a layer of adhesive material 62 adapted to permit the holder 18 to adhere to a support object such as a shower wall. The housing 16 is made of a single piece, or alternatively the blade receiving section and handle section are made as separate pieces that connect.

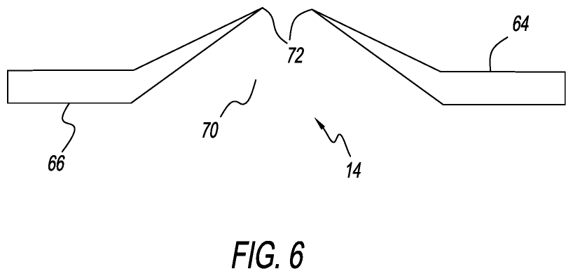

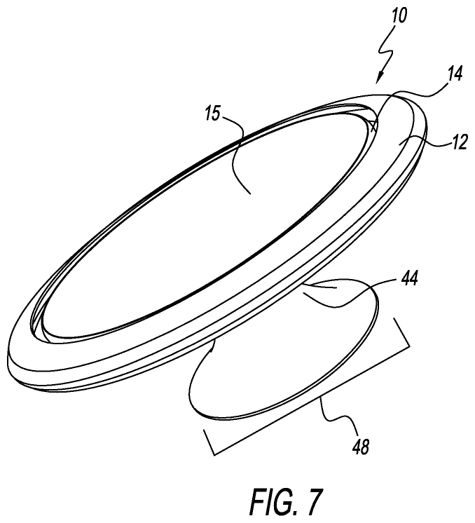

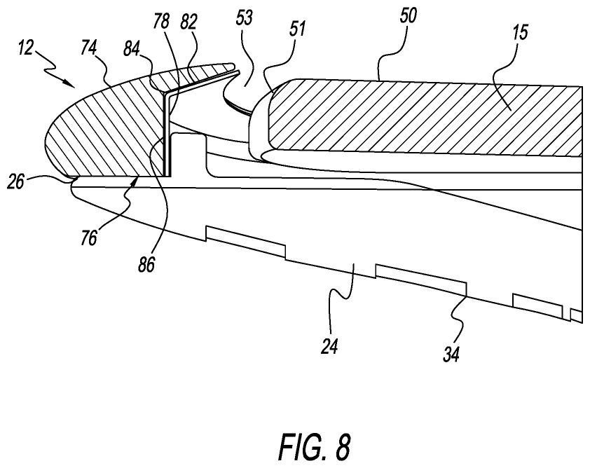

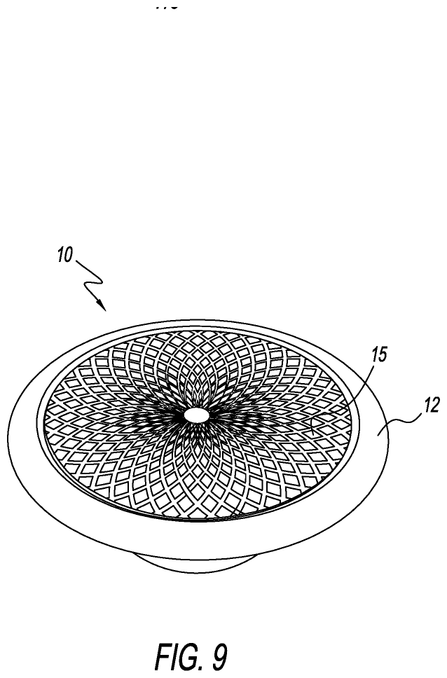

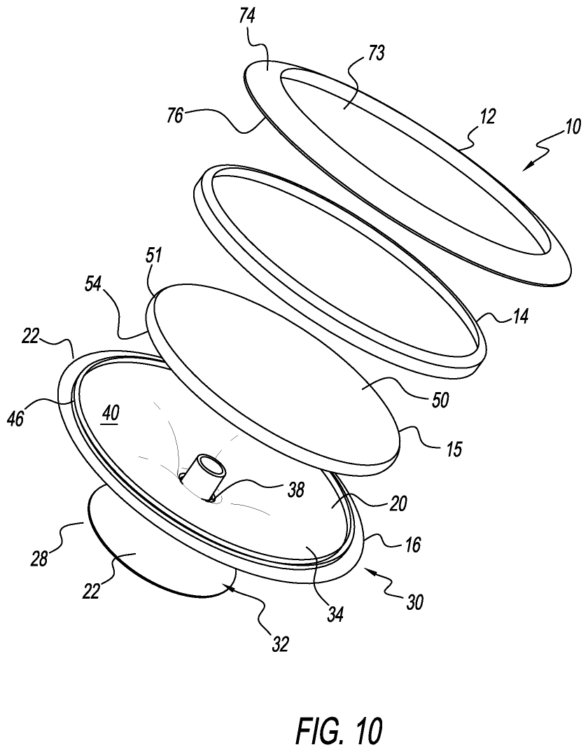

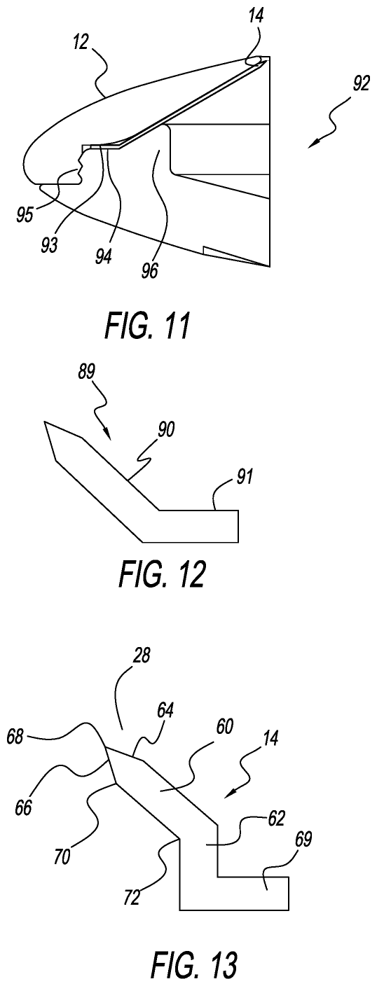

The blade 14 has a convex shape in relation to the housing 16 and a diameter smaller than the diameter of the top edge 26 of the housing 16 so that the blade 14 engages the inner surface 34 of the housing 16 within the clips 46. The convex shape permits the blade to engage with hard-to-reach areas that a flat blade would not be able to reach, increase the surface area shaved compared to conventional flat blades, and facilitates material flexibility to contour to the body's surface. The blade 14 has a top surface 64, a bottom surface 66, and an outer edge 68. A plurality of holes 70 extend from the top surface 64 through to the bottom surface 66 that can be manufactured in any shape, size, and configuration, and allow for movement in any direction to cut hairs while maintaining safety of the user. Preferably, the holes 70 angle inwardly as they extend from the bottom 66 to the top 64 to form a sharp cutting edge 72. Alternatively, the holes 70 extend beyond the top 64 to form a sharp cutting edge as shown in FIG. 6. Preferably, the holes 70 fill the entire area within the outer edge 68, with the holes 70 closer to the center having a diameter smaller than holes 70 closer to the outer edge 68. Having a larger diameter permits the holes 70 to capture longer hairs.

The cap 12 is removably connected to the housing 16 and is adapted to retain the blade 14 between the cap 12 and the housing 16. The cap 12 is of any size, shape, and structure. In the example shown, the cap 12 is formed as a ring with an open center 73, a top surface 74, and a bottom surface 76. The top surface 74 preferably is smooth and the bottom surface 76 has a plurality of grooves 78. The grooves 78 are positioned to align with, and adapted to receive, the clips 46 on the top edge 26 of the housing 16 to frictionally connect the cap 12 to the housing 16 through means of threading, snap on, or twist on. The cap 12 has a width that traps and retains the blade 14 between the bottom surface 76 of the cap 12 and the inner surface 34 of the blade receiving section 30 of the housing 16. In one example, the cap is secured to the housing through use of a magnet, friction fit, or similar type of removable connection.

In operation, a plurality of blades 14 are provided in a stack with a plastic layer of material adhered with adhesive or the like to the top surface 64 of each blade 14. The plastic layer 78 is removed and the blade 14 is placed within the blade receiving section 30 of the housing 16 so that the bottom surface 66 of the blade 14 engages the inner surface 34 of the blade retaining section 30. The cap 12 is then attached to the housing 16 to retain the blade 14 by positioning the grooves 78 over the clips 46 and pressing down or twisting if threaded or bayonet style.

Once assembled, the device 10 is held between the fingers at the transition section 44 as previously described and the top surface 64 of the blade 14, through the open center 73, engages one's skin and as the blade 14 is moved across the skin, hair is cut by the cutting edge 72. The cut hair falls from the blade 14 and into chamber 40 of the blade receiving section 30. The cut hair is removed when the blade 14 is replaced.

An exfoliating cover 82 can be placed over the cap 12 to exfoliate one's skin. The cover 82 has a top surface 84, a bottom surface 86, and an outer edge 88. The top surface 84 has a plurality of nubs or fingers 90 that extend outwardly away from the bottom surface 86. Preferably the cover 82 is made of a resilient material and the outer edge 88 curves back and dwells below the bottom surface. To attach the cover 82 the outer edge 88 is stretched to fit over the top edge 26 of the housing 16 and then released so that the bottom surface 86 of the cover 82 engages the top surface 64 of the cap 12 and the outer surface 36 of the blade retaining section 30 of the housing 16.

When not in use, the device 10 is stored by attaching the device 10 to the holder 18. As an example, the bottom edge 28 of the housing 16 is placed within the shoulder 58 of the holder 18 so that the handle section 32 engages the top 50 of the holder 18. The magnet 48 in the handle section 32 is attracted to the magnet 60 in the holder 18 to hold the device 10 in place.

The magnets can be insert molded, over molded, or friction fit and a single magnet used with an opposing magnet material. Also, when not in use, a protective guard is placed over the cap in similar manner to the exfoliating cover.

In another embodiment, a grooming device 10 includes a cap or rim 12, a blade 14, a center guard or member 15, and a housing 16. The housing 16 has an open top 20, a bottom 22, and a side wall 24. Preferably, the side wall 24 extends from a top edge 26 to a bottom edge 28 in a curved manner that is concave to a central vertical axis of the housing 16 to form a blade receiving section 30 and a handle section 32.

The blade receiving section 30 has an inner surface 34 and an outer surface 36. The inner surface 34 curves from the top edge 26 to a middle wall 38 that forms a chamber 40 for collecting cut hair. The diameter of the top edge 26 is greater than the bottom edge 28 and both are larger than a diameter of a transition section 44 that dwells in between. The design is adapted to permit one to hold the housing 16 by grasping the transition section 44 with a finger on both sides while engaging the back surface 36 of the blade receiving section 30 and the handle section 32. Attached to and extending vertically away from the top edge 26 is a rim or projection 46. The handle section 32 has a magnet 48 attached to or preferably embedded within the handle section 32. The housing 16 is made of a single piece, or alternatively the blade retaining section and handle section are made as separate pieces that connect. In the center of the housing is a bore 42 that is raised into the blade receiving section 30 and extends through the middle wall 38 into the handle section 32.

The center guard 15 is removably attached to the housing 16. The center member 15 has a circular plate portion 50 having a top surface 52 and a bottom surface 54. Extending away from the bottom surface is a shaft 56 that is positioned and configured to be received within the bore 42 of the housing 16. In one embodiment, the shaft 56 is threadably connected within the bore 42. The plate portion 50 of the center guard 15 may have a molded design, hole patterns, different colors, and/or surface finish changes.

The blade 14 preferably has a hollow ring shape which permits shaving in any direction and improving upon the life of the blade and the ergonomic experience of shaving. As there is more surface area in a non-linear blade, the life of the blade is extended while reducing cuts and irritation and eliminating the discomfort that comes with linear motions on existing razors. Preferably the blade has a cutting edge 58, an angled section 60, and a straight or vertical section 62. The cutting edge 58 has a first surface 64 and a second surface 66 that angle outwardly, preferably between fifteen and thirty degrees from a tip or apex 68 and terminate into the angled section 60. The angled section 60 extends from a first transition point 70 at the cutting edge 58 to a second transition point 72 at the vertical section 62. The angled section 60 extends inwardly at an angle in relation to the vertical section 62. The vertical section 62 extends upwardly away from the housing 16 and is vertical or perpendicular in relation to the housing 16. In one embodiment the vertical section 62 terminates in a foot 69 that extends outwardly and perpendicularly in relation to the vertical section 62. In another embodiment the angled section 90 may terminate in a foot 91 that extends outwardly without the need of a vertical section 62.

The cap 12 is removably connected to the housing 16 and is adapted to retain the blade 14 between the cap 12 and the housing 16. The cap 12 is of any size, shape, and structure. In the example shown, the cap 12 is formed as a ring with an open center 73, an outer wall 74, a bottom wall 76, and an inner wall 78. The outer wall 74 extends from a first or top edge 80 to the bottom wall 76 and is preferably curved or arcuate. The inner wall 78 has an angled portion 82 that extends from the top edge 80 to a transition point 84 and then has a straight, vertical, or angled portion 86 that extends to and is perpendicular in relation to the bottom wall 76. The bottom wall 76 is configured to engage the inner surface 34 of the housing 16 and the vertical portion 86 is configured to engage the rim or projection 46 of the housing 16.

The cap 12 has a width that traps and retains the blade 14 between the inner wall 78 of the cap 12 and the rim 46 of the blade receiving section 30 of the housing 16. In one example, the cap is secured to the housing through use of a friction fit, or similar type of removable connection between the vertical portion 86 of the inner wall 78 of the cap 12 and the rim 46 of the housing 16.

In one embodiment the blade 14 can be retained between a bottom edge 93 and a top edge 94 whereas threading 95 is applied to help secure the cap 12 and blade 14 onto the housing. An angled portion 96 provides support to allow for the blade 14 to maintain its proper angle and prevent misalignment or blade misalignment/mutilation during use.

To assemble and use the grooming device 10 the center guard 15 is connected to the housing 16 by inserting the shaft 56 of the center guard 15 into the bore of the housing. The diameter of the plate portion 50 is smaller than the diameter of the blade 14 so that the blade is then placed about the center guard 15 to engage the housing 16. The cap 12 is then attached to the housing 16 to trap the blade 14 between the cap 12 and the housing 16. Preferably the top surface 52 of the center guard 15 is domed or has a convex shape to allow for an easier glide against the skin and to also draw hairs toward the cutting edge 58 of the blade 14. An outer edge 51 of the plate portion 50 of the center guard 15 preferably dwells in a horizontal plane lower than the cutting edge 58 of the blade 14 which allows the blade 14 to cut the hair. Also, preferably a gap 53 between the outer edge 51 of the plate portion 50 of the center guard 15 and the cutting edge 58 of the blade 14 facilitates cutting of hairs and reduces clogging for a continuous shave.

From the above discussion and accompanying figures and claims it will be appreciated that the grooming device 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A grooming device comprising:
a housing having an open top, a bottom, and a side wall wherein the side wall extends from a top edge to a bottom edge in a curved manner that is concave to a central vertical axis of the housing to form a blade receiving section and a handle section;
a center guard having a circular plate portion with a top surface and a bottom surface and a shaft extending away from the bottom surface of the circular plate positioned to be received within a bore of the housing;
a blade attached to the housing about the center guard; and
a cap removably connected to the housing and adapted to retain the blade between the cap and the housing.

2. The device of claim 1 wherein the blade receiving section has an inner surface that curves from the top edge to a middle wall that forms a chamber and an outer surface.

3. The device of claim 2 wherein the top edge is greater than the bottom edge and the diameter of the top edge and the bottom edge are both larger than a diameter of a transition section that dwells between the top edge and the bottom edge.

4. The device of claim 1 wherein the handle section has a magnet embedded within the handle section.

5. The device of claim 1 wherein the blade has a hollow ring shape.

6. The device of claim 1 wherein the blade has a cutting edge, an angled section and a vertical section with the cutting edge having a first surface and a second surface that angles outwardly from an apex and terminates into the angled section.

7. The device of claim 6 wherein the angled section extends from a first transition point at the cutting edge to a second transition point at the vertical section.

8. The device of claim 6 wherein the angled section extends inwardly at an angle in relation to the vertical section.

9. The device of claim 6 wherein the vertical section extends upwardly away from and perpendicular to the housing and terminates in a foot that extends outwardly and perpendicularly in relation to the vertical section.

10. The device of claim 1 wherein the cap is formed as a ring with an open center, an outer wall, a bottom wall, and an inner wall where the outer wall extends and curves from a top edge to the bottom wall.

11. The device of claim 10 wherein the inner wall has an angled portion that extends from the top edge to a transition point and then to a portion that extends perpendicular to the bottom wall.

12. The device of claim 10 wherein the bottom wall is configured to engage the inner surface of the housing and the vertical portion is configured to engage a projection on the housing.
